(19) United States
(12) Patent Application Publication
(10) Pub. No.: US 2008/0034540 A1
(43) Pub. Date: Feb. 14, 2008

(54) Hinge System

(76) Inventors: Hal Avery, Needham, MA (US); Richard Miller, Needham, MA (US); Benjamin Powers, Boston, MA (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/503,573

(22) Filed: Aug. 11, 2006

(51) Int. Cl. E05F 1/08

(52) U.S. Cl. 16/286

(57) ABSTRACT

A hinge system for opening a cover pivotably connected to a device housing. The hinge system includes a rotating member in the device housing and a shaft connected between the cover and the rotating member. A non-rotating member in the device housing receives the rotating member and a spring connected to the device housing and biased to rotate the shaft.

### FIELD OF THE INVENTION

This subject invention relates to a hinge system for opening a cover pivotably connected to a device housing (in one example, a small portable scanner) in a steady and controlled fashion.

### BACKGROUND OF THE INVENTION

It is desirable in electronic devices with covers to have the cover open in a steady and controlled fashion.

U.S. Pat. No. 6,606,762, incorporated herein by this reference, discloses a shaft in the device cover, a line wound around the shaft, and a spring connected to the line to open the cover automatically. Since the line and the spring extend along the sides of the device, end caps are required to house the springs and the lines. In some devices, small portable scanners for example, end caps are not feasible.

U.S. Pat. No. 6,178,085, also incorporated herein by this reference, discloses a calculator with a lid which also forms a stand for the calculator. The lid opening mechanism includes a damping drum and a coil spring inside a bore in the tubular portion of the lid.

### SUMMARY OF THE INVENTION

It is therefore an object of this invention to provide a new hinge system for a cover pivotably connected to a device housing for opening the cover in a steady and controlled fashion.

It is a further object of this invention to provide such a hinge system which does not require end caps.

It is a further object of this invention to provide such a hinge system which is easy to manufacture, assemble, and use.

It is a further object of this invention to provide such a hinge system which is reliable.

The subject invention results from the realization that a novel, easy to manufacture, and easy to assemble hinge system for opening a device cover in a steady and controlled fashion includes a cover shaft connected to a rotating member fit within a non-rotating member forming a damping mechanism and a spring biased to rotate the shaft when the cover is opened.

The subject invention, however, in other embodiments, need not achieve all these objectives and the claims hereof should not be limited to structures or methods capable of achieving these objectives.

This invention features a hinge system for opening a cover pivotably connected to a device housing. The typical hinge system includes a rotating member in the device housing, a shaft connected between the cover and the rotating member, a non-rotating member in the device housing which receives the rotating member, and a spring connected to the device housing and biased to rotate the shaft.

In one example, the cover includes a bore and the shaft extends through the bore. Typically, the shaft is molded in the bore. Preferably, damping material is disposed between the rotating member and the non-rotating member. In one example, the damping material is grease.

In one example, the spring is connected on one end to the shaft. The preferred rotating member includes a lever arm with a socket which receives the shaft. The shaft then includes a jog between the lever arm and the cover and the lever arm may include a slot for positioning the spring.

In the preferred embodiment, the device housing includes a journal between the jog in the shaft and the cover, the non-rotating member includes a key received in a socket in the device housing, and the device housing includes a latch for releasably locking the cover in a closed position.

The hinge system may be used in connection with a scanner or other electronic device. One hinge system for opening a cover pivotably connected to a scanner housing in accordance with this invention includes a rotating lever member in the scanner housing with a cylinder extending therefrom, a shaft connected to the cover and including a jog portion connected to the lever arm, a non-rotating cylinder in the scanner housing which receives the lever member cylinder therein, and a spring connected to the scanner housing and biased to rotate the shaft.

### BRIEF DESCRIPTION OF THE DRAWINGS

Other objects, features and advantages will occur to those skilled in the art from the following description of a preferred embodiment and the accompanying drawings, in which:

FIG. 1 is a schematic three-dimensional front view of an example of a device with an automatic opening cover in accordance with the subject invention;

FIG. 2 is a schematic three-dimensional front view showing the primary components of the hinge mechanism of the subject invention;

FIG. 3 is a schematic three-dimensional top view showing how the hinge mechanism components shown in FIG. 2 are assembled within the device housing shown in FIG. 1;

FIGS. 4A-4B are three-dimensional schematic views of the rotating cylinder component of the damping mechanism shown in FIGS. 2-3;

FIG. 5 is a schematic three-dimensional view of the non-rotating cylinder component of the damping mechanism shown in FIGS. 2-3;

FIG. 6 is a schematic three-dimensional view of the cover and shaft components of the invention shown in FIGS. 1-3;

FIG. 7 is a schematic three-dimensional top view showing an alternative embodiment of a hinge mechanism assembled in a device housing; and

FIG. 8 is a schematic three-dimensional view of the rotating cylinder component shown in FIG. 7.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

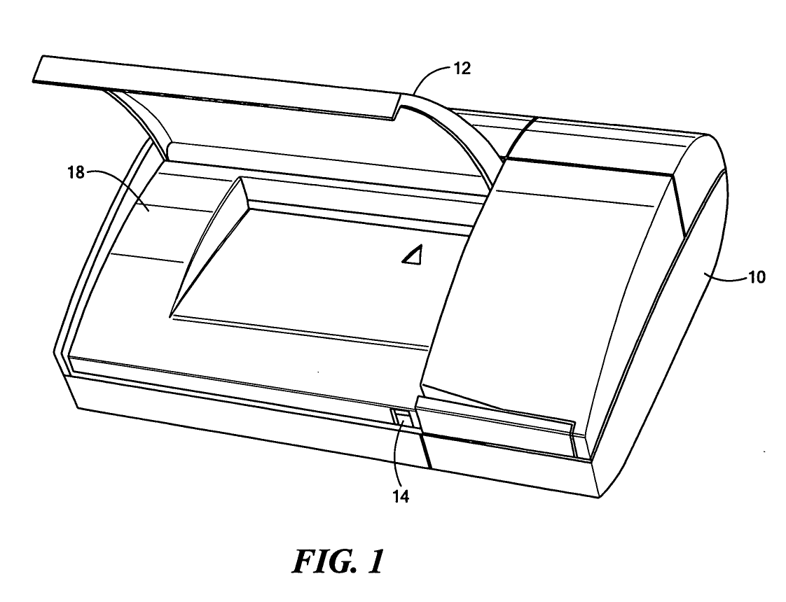

FIG. 1 shows scanner device housing 10 with cover 12 connected thereto. The hinge system of the subject invention automatically opens cover 12 in a steady and controlled fashion once latch 14, which releasably locks cover 12 in a closed position, is disengaged. Cover 12 includes a bore within tubular portion 16 through which a shaft extends. Typically, the shaft is molded into this bore and, on end 18, the shaft is received in a recess in device housing 10.

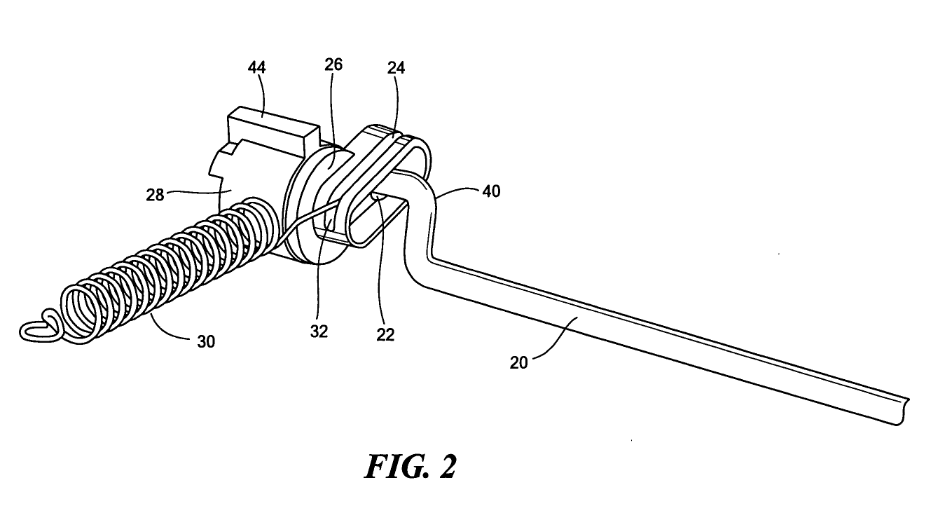

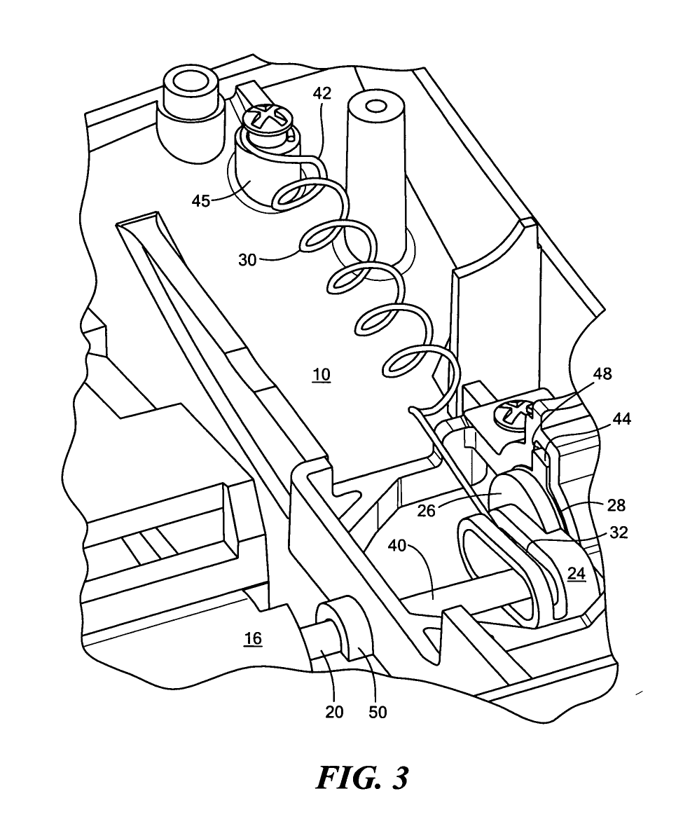

In one example, shaft 20, FIG. 2, has an opposite end received in socket 22 of lever arm 24 via a slip fit. Lever arm 24, in turn, is attached to rotating damping cylinder 26 which is received in non-rotating member 28. Extension spring 30 is connected to shaft 20 and held in place via slot 32 in lever arm 24. Damping grease may be placed between rotating damping cylinder 26 and non-rotating damping cylinder 28. FIG. 3 shows these components in place inside device housing 10. The damping mechanism of this invention includes plastic cylinders 26 and 28 which are concentric to each other and which fit together in a nested manner as cylinder 26 slides into cylinder 28. The gap between the two nested cylinders is filled with damping grease which causes the cylinders to resist any high-speed rotation in relation to each other.

Rotating cylinder 26 of the damping mechanism has a slotted section 24 that extends outward from the axis of rotation. The door shaft fits into this slot thus coupling the rotation of the damping mechanism to the rotation of the door itself. The door shaft has a jog 40 to ensure that the coupling point where shaft 20 joins with rotating cylinder 26 is not at the axis of rotation of either rotating cylinder 26 or the main portion of shaft 20. In an alternative design, however, if adequate space exists, shaft 20 and rotating cylinder 26 could rotate about the same axis.

Extension spring 30 fits through slot 32 in lever arm 24 and couples directly to shaft 20. Since this connection point is eccentric from the center of rotation of the cover and rotating cylinder 26, the spring force causes the door shaft 20 to rotate. The door shaft also causes the damping mechanism 26 to rotate and the resultant force balance between the rotation torque from the spring 30 and the opposing damping torque from cylinder 26 within cylinder 28 and the damping grease results in a steady lifting of cover 12, FIG. 1.

Metal spring 30 is extended when the cover is releasably locked in the closed position as shown in FIG. 3. Spring end 42 is secured to post 45 within housing 10. The other end of spring 30 is secured through slot 32 in lever arm 24 to shaft 20 via a loop. Key 44 on non-rotating cylinder 28 is received in socket 48 formed inside device housing 10. Journal 50 also formed in device housing 10 between jog 40 in shaft 20 and cover tubular portion 16 maintains the position of shaft 20 in the device.

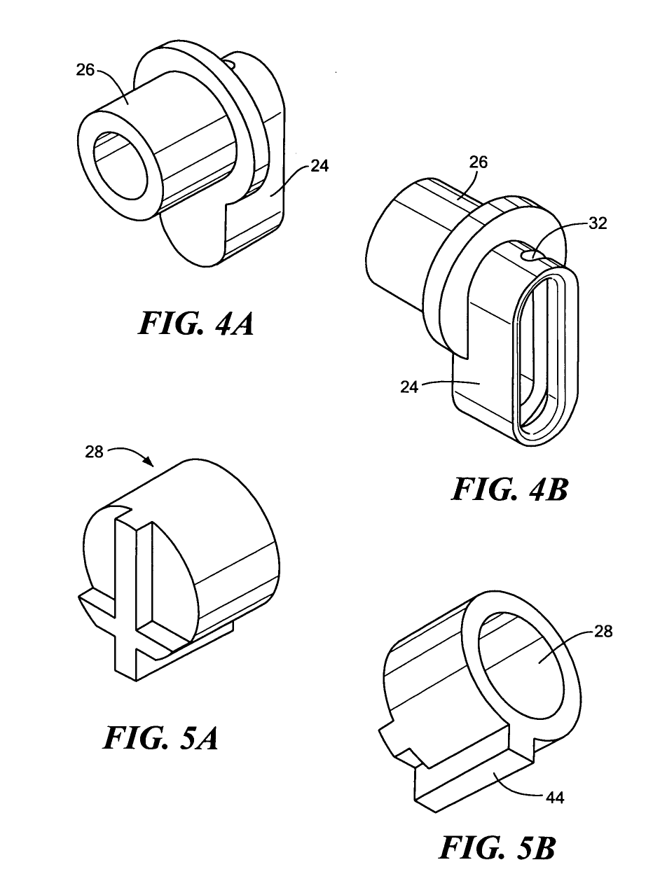

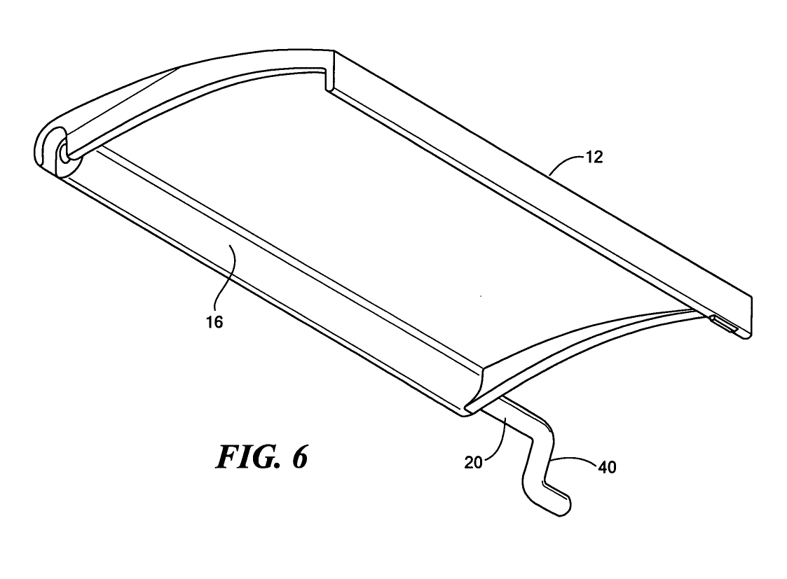

Typically, shaft 20 and spring 30 are made of steel and rotating cylinder 26, lever arm 24, and non-rotating cylinder 28 are made of ABS plastic molded pieces. In one example, lever arm 24 and rotating cylinder 26 were unitary in construction as shown in FIGS. 4A-4B. The outside diameter of rotating cylinder 26 is 7.5-mm, the inside diameter of non-rotating cylinder 28, FIG. 5 is 7.78 mm, and the outside diameter of non-rotating cylinder 28 is 10.88 mm. FIG. 6 shows cover 12 with shaft 40 fixed in place relative to door 12.

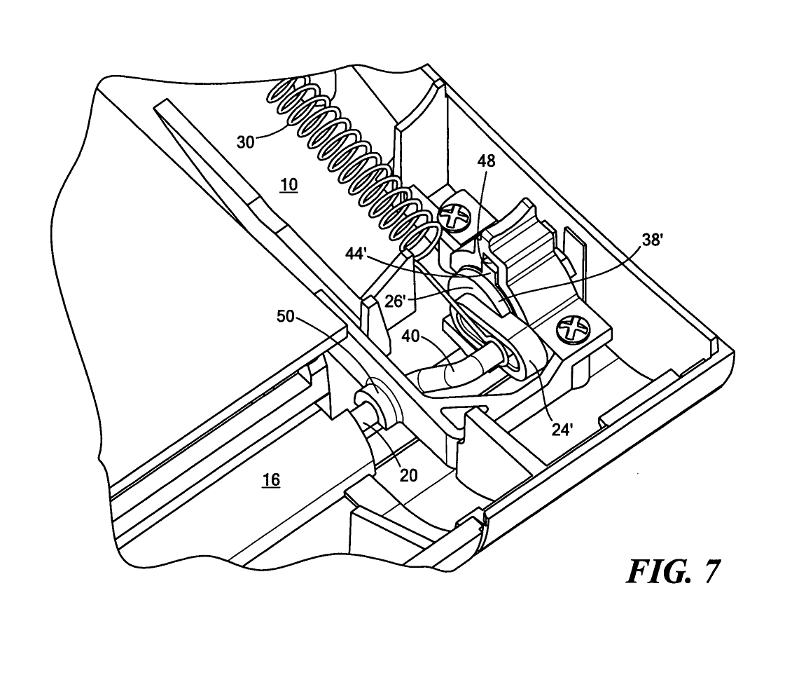

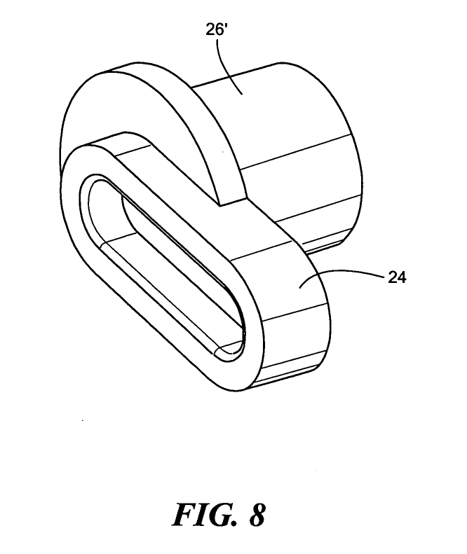

FIG. 7 shows an alternative embodiment where extension spring 30 couples directly to shaft 20 adjacent rotating lever arm 24′. Since this connection point is eccentric from the center of rotation of the cover and rotating cylinder 26′, the spring force causes the door shaft 20 to rotate. The door shaft also causes the damping mechanism 26′ to rotate and the resultant force balance between the rotation torque from the spring 30 and the opposing damping torque from cylinder 26 within cylinder 28 and the damping grease results in a steady lifting of cover 12, FIG. 1. FIG. 8 shows the construction of integral lever arm 24′ and rotating cylinder 26′.

The result, in any embodiment, is a novel, easy to manufacture, easy to assemble, and easy to use hinge system for opening a device cover in a steady and controlled fashion.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments, such as hinge systems for devices other than scanners, will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

What is claimed is:

1. A hinge system for opening a cover pivotably connected to a device housing, the hinge system comprising:
a rotating member in the device housing;
a shaft connected between the cover and the rotating member;
a non-rotating member in the device housing which receives the rotating member; and
a spring connected to the device housing and biased to rotate the shaft.

2. The hinge system of claim 1 in which the cover includes a bore and the shaft extends through the bore.

3. The hinge system of claim 2 in which the shaft is molded in the bore.

4. The hinge system of claim 1 further including damping material between the rotating member and the non-rotating member.

5. The hinge system of claim 4 in which the damping material is grease.

6. The hinge system of claim 1 in which the spring is connected on one end to the shaft.

7. The hinge system of claim 1 in which the rotating member includes a lever arm.

8. The hinge system of claim 7 in which the lever arm includes a socket which receives the shaft.

9. The hinge system of claim 7 in which the shaft includes a jog between the lever arm and the cover.

10. The hinge system of claim 7 in which the lever arm includes a slot for positioning the spring.

11. The hinge system of claim 9 in which the device housing includes a journal between the jog in the shaft and the cover.

12. The hinge system of claim 1 in which the non-rotating member includes a key received in a socket in the device housing.

13. The hinge system of claim 1 in which the device housing includes a latch for releasably locking the cover in a closed position.

14. The hinge system of claim 1 in which the device is a scanner.

15. A hinge system for opening a cover pivotably connected to a scanner housing, the hinge system comprising:
a rotating lever member in the scanner housing with a cylinder extending therefrom;
a shaft connected to the cover and including a jog portion connected to the lever arm;
a non-rotating cylinder in the scanner housing which receives the lever member cylinder therein; and
a spring connected to the scanner housing and biased to rotate the shaft.
